(19) United States
(12) Patent Application Publication
(10) Pub. No.: US 2006/0161553 A1
(43) Pub. Date: Jul. 20, 2006

(54) Systems and methods for providing user interaction based profiles

(75) Inventor: Sky Woo, San Francisco, CA (US)

Correspondence Address: CARR & FERRELL LLP, 2200 GENG ROAD, PALO ALTO, CA, 94303, US

(73) Assignee: Tiny Engine, Inc.

(21) Appl. No.: 11/212,352

(22) Filed: Aug. 26, 2005

Related U.S. Application Data
(63) Continuation-in-part of application No. 11/099,356, filed on Apr. 4, 2005.
(60) Provisional application No. 60/645,135, filed on Jan. 19, 2005.

(51) Int. Cl. G06F 17/30

(52) U.S. Cl. 707/10

(57) ABSTRACT

A system and method for providing user interaction based profiles is provided. The method comprises monitoring one or more user activities associated with a network. The one or more user activities are then analyzed utilizing psychological dimensions. A user profile is generated based upon the analysis.

### CROSS-REFERENCE TO RELATED APPLICATIONS

The present application is a continuation-in-part of and claims the benefit and priority of U.S. patent application Ser. No. 11/099,356, filed Apr. 4, 2005 and entitled “SYSTEMS AND METHODS FOR PROVIDING SEARCH RESULTS BASED ON LINGUISTIC ANALYSIS,” which claims the benefit and priority of U.S. provisional patent application Ser. No. 60/645,135, filed Jan. 19, 2005 and entitled “SYSTEMS AND METHODS FOR PROVIDING SEARCH RESULTS BASED ON LINGUISTIC ANALYSIS,” both of which are incorporated herein by reference.

The subject matter of this application is related to U.S. patent application Ser. No. 11/______ filed on ______ and titled “PSYCHO-ANALYTICAL SYSTEM AND METHOD FOR AUDIO AND VISUAL INDEXING, SEARCHING AND RETRIEVAL,” which is incorporated herein by reference.

### BACKGROUND OF THE INVENTION

1. Field of the Invention

The present invention relates generally to search engines and content based web sites, and more particularly to systems and methods for providing user interaction based profiles.

2. Description of Related Art

Conventionally, networks, such as the Internet, have made searching for information more simplified as compared to going to a library and searching through indexes to find articles or books, for example. Nowadays, a user may simply enter words into a website query box in order to find information related to the entered words. The website providing the query box uses a search engine to scrutinize numerous documents on the Internet and return documents containing the words, also known as keywords, entered by the user.

Search engines are widely utilized over networks for locating the information sought by the user. Conventionally, search engines employ keyword matching in order to return web page links to the user seeking data related to the entered keywords. Accordingly, when the search engine displays links to pertinent web pages to the user, the links are displayed in order of the web page with the most keywords.

Because the use of search engines for locating web pages has become so popular, advertisers often flock to popular web pages in order to attract the largest audiences. Users that enter web pages located via the search engine or content based websites may click on one or more advertisements associated with the web pages. Accordingly, each web page may have numerous advertisements associated therewith.

Disadvantageously, few of the advertisements are relevant to the user's individual preferences. The advertisements may be tailored to the subject matter or keywords of the particular web page, but customization to match this subject matter or keywords often fails to reach and serve the ideal audience.

Therefore, there is a need for a system and method for providing user interaction based profiles.

### SUMMARY OF THE INVENTION

The present invention provides a system and method for providing user interaction based profiles. In a method according to some embodiments, one or more user activities associated with a network are monitored. The one or more user activities are then analyzed utilizing psychological dimensions. A user profile is generated based upon the analysis.

### BRIEF DESCRIPTION OF THE DRAWINGS

FIG. 1 illustrates an exemplary architecture for performing linguistic analysis of network content;

FIG. 2 illustrates an exemplary environment for monitoring user activities over a network in order to generate user profiles;

FIG. 3 illustrates a flow diagram of an exemplary process for providing user interaction based profiles;

FIG. 4 illustrates a schematic diagram showing a process for generating targeted advertisements according to some embodiments; and

FIG. 5 illustrates a schematic diagram illustrating exemplary generation of a portal based on psychological parameters to generate profiles.

### DESCRIPTION OF EXEMPLARY EMBODIMENTS

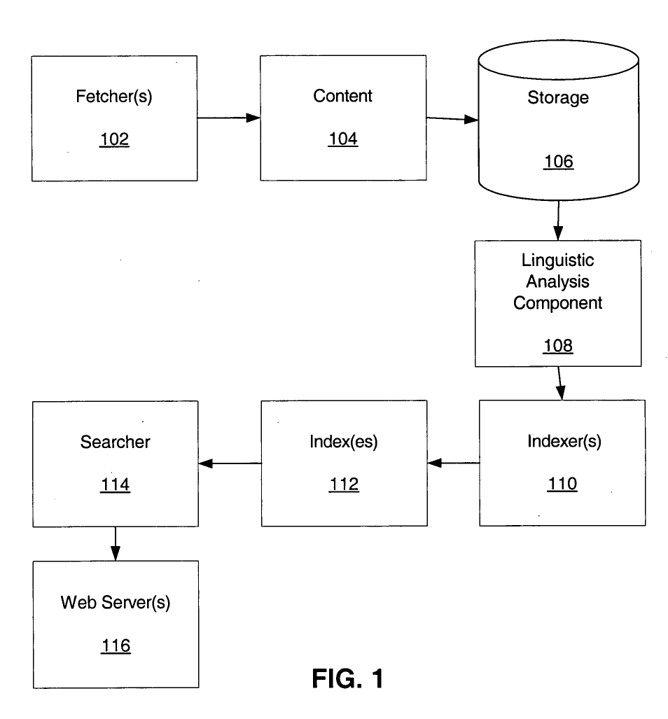

Referring to FIG. 1, an exemplary architecture for providing user interaction based profiles based on a search engine that performs linguistic analysis is shown. One or more fetchers 102 download web pages from various web sites. Content 104 from the web pages may be sent to storage 106. The content 104 may be compressed web pages, unique identifiers for locating the web pages, and so on. In some embodiments, additional servers may be provided for compressing the web pages, providing URLs for the web pages, and so forth.

A linguistic analysis component 108 retrieves the content 104 from the storage 106 and utilizes linguistic parameters to analyze the content 104. The linguistic analysis component 108 may separate the content 104 into segments, for example, and score each of the segments within the content 104 based on the linguistic parameters utilized. For instance, the linguistic analysis component 108 may separate a news story (i.e. the content 104) into segments according to paragraph structure and use optimism linguistic parameters to score individual paragraphs based on how optimistic the individual paragraphs are with respect to the language utilized in the individual paragraphs.

One or more indexers 110 parses the content 104. In the example of the segments of the news story broken down according to the individual paragraphs, the indexers 110 associate the segments of the news story with the scores of the individual segments. The indexers 110 can also associate an overall score provided by the linguistic analysis component 108 for the news story as a single document. In some embodiments, the indexers 110 decompress the content 104 if the content 104 was compressed before being forwarded to the storage 106. Additionally, the indexers 110 distribute the content 104 to one or more indexes 112.

A searcher 114, which is run by one or more web servers 116, matches search terms with the content 104 in the indexes 112. Results are then returned to a user presenting a query, via the one or more web servers 116, based on the matched search terms and the linguistic scores of the content 104. In some embodiments, the user may select the linguistic parameters, such as “readability”, for example, in which case the searcher 114 matches the search terms and the linguistic parameter specified by the user to the content 104 having a high score for readability and the search terms.

The environment shown in FIG. 1, or a similar environment, may be utilized to map user requests for information that has been analyzed utilizing linguistic parameters and user interaction with the information received. Accordingly, user interaction based profiles may be generated from user interaction with the information delivered utilizing the environment discussed in FIG. 1. However, fewer or more components may comprise the environment discussed in FIG. 1 and still fall within the scope of various embodiments.

Various linguistic parameter options may be provided to the user, such as readability, optimism of the content 104, pessimism of the content 104, complexity, sarcasm, humor, rhetoric, political leaning, and so forth. Any linguistic parameters are within the scope of various embodiments.

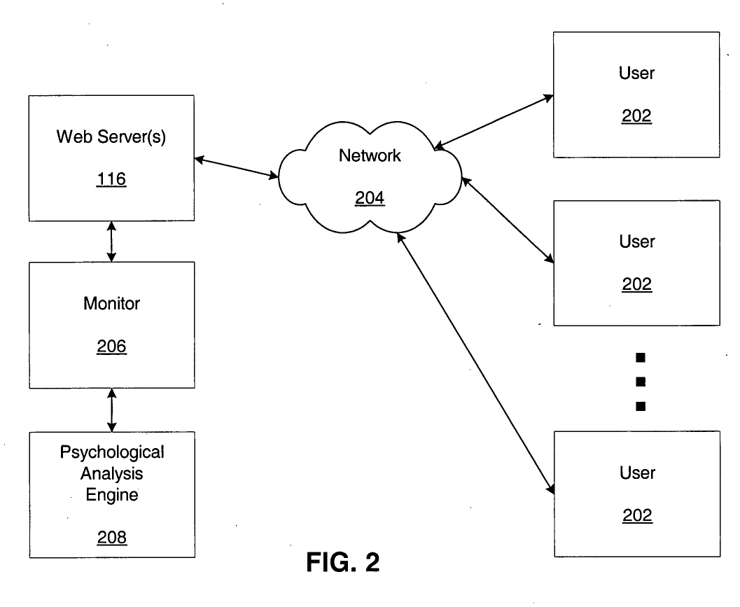

Referring now to FIG. 2, an exemplary environment for monitoring user activities in order to generate user profiles is shown. One or more users 202 may access information provided by the web server(s) 116 (FIG. 1) via a network 204. The network 204 may comprise any type of network, such as a wide area network (WAN) or a local area network (LAN).

A monitor 206 tracks user activities via the network 204. Specifically, the monitor 206 tracks user interaction with information obtained via the network 204. The monitor 206 can track user searches, requests, actions, type of information retrieved by the user, and so forth. As discussed herein, the information obtained from the web server(s) 116 may have been analyzed utilizing the linguistic analysis component 108 (FIG. 1) according to some embodiments. Any other type of analysis may have been performed, such as behavioral analysis, interaction with audio and visual materials analysis, and so forth. However, any type of information may be obtained by the user and any interaction with the information may be tracked by the monitor 206.

The monitor 206 is coupled to a psychological analysis engine 208 that analyzes the activities of the users 202 tracked by the monitor 206. In some embodiments, the monitor 206 may reside in the psychological analysis engine 208. In other embodiments, the linguistic analysis component 108 may be utilized to provide analysis of the activities of the users 202.

The psychological analysis engine 208 utilizes various psychological parameters to analyze the user 202 activities. A profile is then created for the user 202. The profile may include user preferences, typical behaviors, types, and so forth. The profile may be sold, or otherwise provided, to commercial entities, such as advertising companies, marketing companies, publishers, manufacturers, or any other entities.

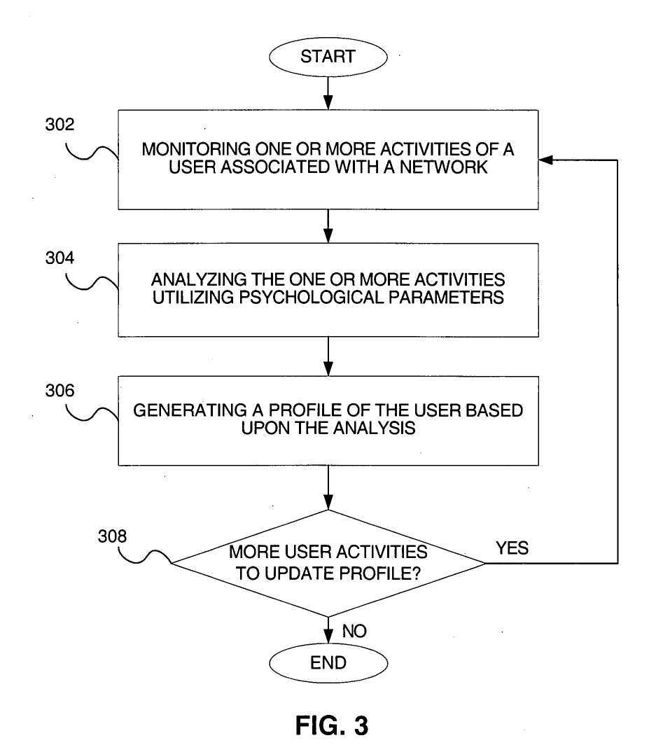

FIG. 3 illustrates a flow diagram of an exemplary process for providing user interaction based profiles. At step 302, one or more activities of a user associated with a network, such as the network 204 discussed in FIG. 2, are monitored. As discussed herein, the monitor 206 discussed in FIG. 2 may be utilized to monitor the activities of the users 202 over the network.

At step 304, the one or more activities are analyzed utilizing psychological parameters. The psychological analysis engine 208 (FIG. 2) utilizes the psychological parameters, or psychological dimensions, in order to analyze the user activities, as discussed herein.

The one or more user activities may include interaction with application data, content, user usage habits and statistics to index information across many linguistic and demographic dimensions across any written language or language of notation (including music and representational languages, such as computational and mathematical languages). According to exemplary embodiments, the one or more activities comprise search requests. The one or more activities may comprise user interaction with information obtained via the network.

Some of these psychological parameters may be defined as linguistic and demographic surveys, assessments, measurements and estimates of textual and electronic data content, user habits, tendencies, representational notational languages and written or verbal preferences that identify persons, objects, concepts, ideas related to different descriptive dimensions, and so forth. The psychological dimensions can be organized in categories and different relational structures, according to exemplary embodiments.

At step 306, a profile of the user 202 is generated based upon the analysis. Thus, the psychological parameters are utilized to generate a profile of the user 202, according to the user's 202 interaction with content obtained via the network 204.

The different psychological parameters utilized to provide the analysis upon which to base the profile provide a greater understanding and method to identify different target audiences and markets. For example, the psychological analysis engine 208 (FIG. 2), utilizing the process discussed in FIG. 3 or a similar process, is capable of identifying neurotic men suffering from social and professional anxiety in the workplace, or happy, outgoing teenagers who happen to also like heavy metal music and sports. As another example, the psychological analysis engine 208 can identify bored, but otherwise happy working age adults who respond well to audio and video online materials, but are only interested in DVDs and have no interest in online music. Types and topics for commercial entities can be tailored to a target audience based on the profiles, so that every advertising, marketing, and selling dollar may be utilized to gain a high return on investment.

For example, the profile may be sold, or otherwise provided, to commercial entities. The commercial entity may then utilize the profile to customize content, such as advertising, marketing materials, or publications. Any type of content may be customized based on the profile of users 202. In exemplary embodiments, a category is assigned to the user 202 according to the profile. The category assigned to the user 202 may then be matched with a target audience associated with the commercial entity. The user 202 may be grouped with other users 202 according to the profile and bids for the grouping of the users 202 may be accepted or the grouping of user profiles may be sold to the commercial entities. For example, users 202 with profiles that match the category “Unhappy Male Republicans” may be grouped together. This grouping may then be sold to commercial entities that may want to advertise to a target audience with that profile.

Any type of preferences, behaviors, and so forth may be captured by the profile. The profile can be linked and customized to keyword searches so specific profiles can be searched for by users, such as the commercial entities. The commercial entities can also customize an experience for users with certain profiles. For example, users with profiles including behavioral tendencies toward immediately clicking through to locate the price of a product prior to reading about the product may be presented with an environment that includes information and price immediately. Any type of customization of a website, advertisement, or other environment can be provided based on the user profiles. Further, simulations and dynamic information models can be generated from statistical, mathematical, rule based, and business logic based analysis according to the profile information in exemplary embodiments.

At step 308, the psychological analysis engine 208 determines whether additional user activities have occurred that may be utilized to update the profile. If the profile of the user 202 does need to be updated, the psychological analysis engine 208 obtains more user activity data from the monitor 206 (FIG. 2). The psychological analysis engine 208 may not update the profile for any reason, such as no more user activity exists, the additional user activity is consistent with the profile, the user profile has already been grouped and/or categorized, and so forth.

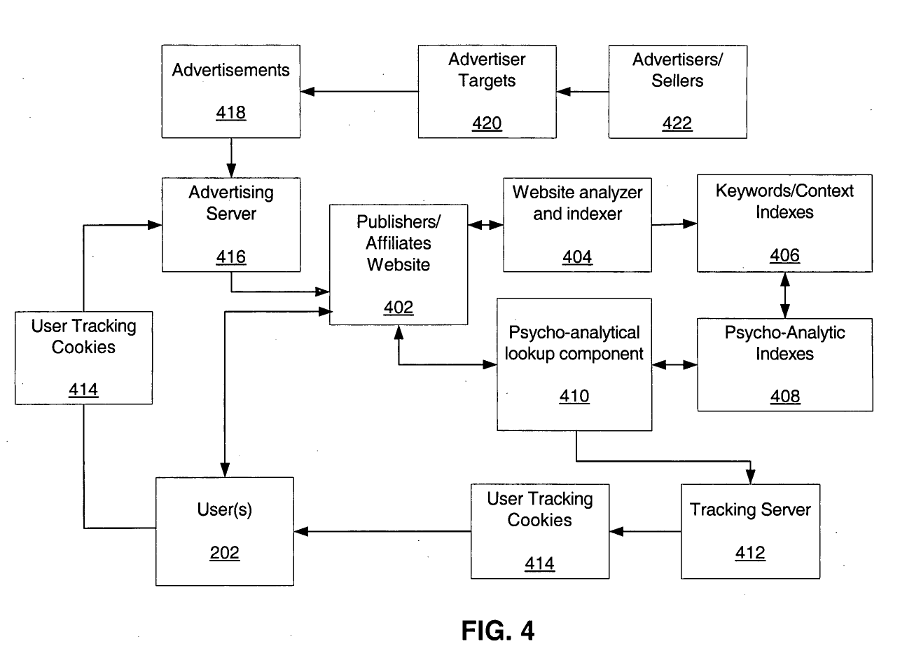

FIG. 4 shows a schematic diagram of a process for generating targeted advertisements according to some embodiments. One or more users 202 (FIG. 2) access a publishers/affiliates website 402. For example, as discussed in FIG. 2, the users 202 may access any websites provided by one or more web servers 116 via the network 204. The publishers/affiliates website 402 discussed herein provides advertising targeted toward the users 202 for which profiles have been generated, as discussed herein. Any type of website may comprise the publishers/affiliates website 402, such as a search engine website, a news website, a retail website, and so on.

Typically, a website analyzer and indexer 404 previously generated keywords/context indexes 406 from the publishers/affiliates website 402. As discussed in FIG. 1, the linguistic analysis component 108 can analyze the language from various websites, such as the publishers/affiliates website 402, in order to provide search results to users 202 based on a linguistic analysis of the content 104 of the particular website. If the website analyzer and indexer 404 did not perform analysis and indexing previously, the website analyzer and indexer 404 may perform analysis and indexing of the publishers/affiliates website 402 when the user(s) 202 activity are tracked at the publishers/affiliates website 402 location. The keywords/context indexes 406 for the publishers/affiliates website 402, such as the indexes 112 discussed in FIG. 1, may be created.

The keywords/context indexes 406 may also be utilized to generate psycho-analytic indexes 408. The psycho-analytic indexes 408 may also be generated by the psychological analysis engine 208 discussed in FIG. 2. In some embodiments, the website analyzer and indexer 404 comprises a component of the psychological analysis engine 208. The psycho-analytic indexes 408 may include an analysis of the information included on the publishers/affiliates website 402 according to the psychological parameters discussed herein.

A psycho-analytical lookup component 410 searches the psycho-analytic indexes 408 for information about the publishers/affiliates website 402 when a tracking server 412 indicates that a particular user 202 is visiting the publishers/affiliates website 402. If information about the publishers/affiliates website 402 is located in the psycho-analytic indexes 408 the psycho-analytic lookup component 410 passes the information to the tracking server 412. If the information is not located by the psycho-analytic lookup component 410, the website analyzer and indexer 404 generates the information for the psycho-analytic lookup component 410 to retrieve from the psycho-analytic indexes 408. The tracking server 412 may comprise the monitor 206 discussed in FIG. 2 or the monitor 206 may comprise a component of the tracking server 412 according to some embodiments.

The tracking server 412 creates one or more user tracking cookies 414, or similar tracking methods or devices, to provide to a computing device associated with the users 202. The user tracking cookies 414 include the psycho-analytic information or links from the psycho-analytic indexes 408. The psycho-analytic information may comprise user profiles, a profile of the publishers/affiliates website 402, and/or a profile of the type of users 202 that typically visit the publishers/affiliates website 402. The profile of the user 202, as discussed herein, may include any data related to the user's 202 interaction with the publishers/affiliates website 402.

The user tracking cookies 414 are then matched with targets sought by an advertising server 416. In other words, the advertising server 416 generates or retrieves advertisements 418 for the users 202 visiting the publishers/affiliates website 402 based on the user profiles or any other information included in the user tracking cookies 414. In one embodiment, the user tracking information, such as the profiles, are provided in a form other than user tracking cookies 414. Any manner of providing the user profiles to the advertising server 416 is within the scope of various embodiments. Further, the advertising server 416 may include publications, promotions, or any other content, according to exemplary embodiments.

The advertisements 418 may be generated based on advertiser targets 420 set forth by advertisers/sellers 422. The advertisers/sellers 422 can also generate the advertiser targets 420 and/or the advertisements 418 based on the user profiles.

In exemplary embodiments, the psychological analysis engine 208 comprises a system that tracks and studies the users 202 in order to match the users 202 with patterns of keywords, contextual information, psycho-linguistic dimensions, psycho-demographic dimensions and any other data that may comprise the profile of the user 202. The profiles may then be sold to the advertisers/sellers 422.

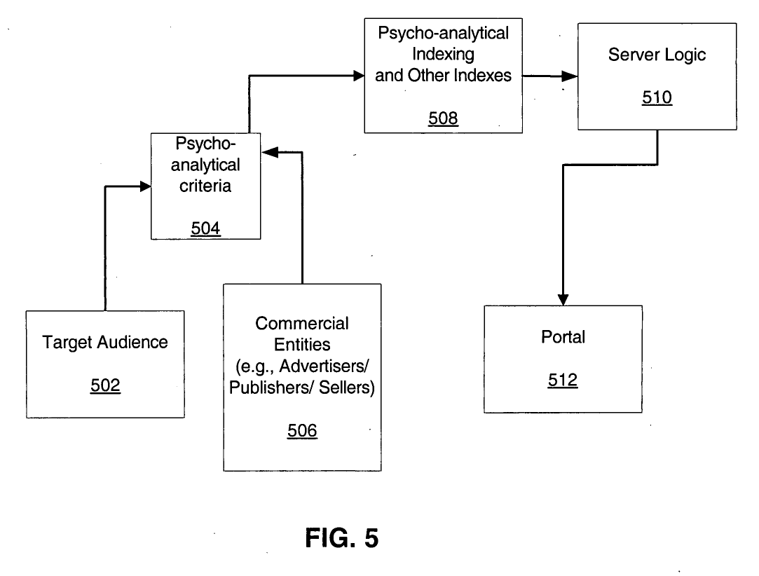

Referring now to FIG. 5, a schematic diagram illustrating exemplary generation of a portal based on psychological parameters to generate profiles shown. A target audience 502, such as one or more of the users 202 (FIG. 2) discussed herein, are evaluated based on psychological parameters and psycho-analytic criteria 504 generally. Commercial entities 506, such as advertisers, publishers, sellers, or any other commercial entities input information about themselves, such as desired target audience, products, and so forth. The target audience 502 and the commercial entities 506, such as the advertisers/sellers 422 discussed in FIG. 4, are analyzed utilizing the psycho-analytical criteria 504. The target audience 502 may be matched with the one or more commercial entities 506 and/or each may be profiled.

In exemplary embodiments, the commercial entities 506 may be presented with real time user interaction based profiles, so that the commercial entities 506 can view the profiles of the users on the commercial entities 506 websites at that moment in time. Accordingly, the commercial entities 506 can make real time decisions about what type of advertising, marketing, designs, and so forth to display according to the profiles of the users visiting the websites at that moment. Individual user interaction based profiles can be represented visually or statistically through an interface to the commercial entities 506. The interface may allow the commercial entities 506 to select and/or combine different profiles or dimensions or parts of the profiles together.

The analysis and/or the profile for each of the target audience 502 and the commercial entities 506 is indexed into psycho-analytic indexes and other indexes 508, such as the psycho-analytic indexes 408 discussed in FIG. 4, the index(es) 112 discussed in FIG. 1, and/or any other indexes or storage mediums.

Server logic 510 utilizes the psycho-analytic indexes and other indexes 508 in order to generate a portal 512. The server logic 510 may comprise logic from the advertising server 416 (FIG. 4), the psychological analysis engine 208, or from any other computing device. The portal 512 may be specialized based on the profiles of the target audience 502 and/or the commercial entities 506. Any type of portal 512 generated based on the psycho-analytic indexes and other indexes 508 is within the scope of various embodiments. According to some embodiments, the users 202 are targeted through matching the psycho-analytic and other indexes 508 with user 202 interactions.

In exemplary embodiments, users 202 or commercial entities 506 can automatically index one or more web pages, web sites, information stores, and/or data networks to be presented to advertisers for context sensitive bidding, psycho-linguistic sensitive bidding, psycho-demographic sensitive bidding, profile sensitive bidding, or for any other type of bidding by utilizing the psycho-analytic indexes 408. Context sensitive bidding, psycho-linguistic sensitive bidding, psycho-demographic sensitive bidding, and profile sensitive bidding refer to the manner in which the information gathered has been sorted by sensing types, indexed, grouped, and so forth. In exemplary embodiments, the sensing types discussed herein may be mixed and matched in varying combinations. Further, the profiles may automatically be categorized according to sensing types according to exemplary embodiments.

A statistical data collection from the profiles can be marketed to any type of commercial entities 506 or any other individuals, organizations, and so forth. The statistical data may be utilized in brand management, analysis of user experiences, customer service and management, sales related tasks, and so forth. The data may also be utilized in e-commerce systems to better tailor products, services, and user purchase experiences, for example. The statistical data can be utilized for any purpose.

In some embodiments, commercial entities 506 can specify profiles that the commercial entities 506 desire with keywords. For example, various commercial entities 506 can bid for keywords or types of textual notation that represent profiles. The bidding can occur for keywords that represent profiles (e.g. “GenerationX”), parts of profiles, profiles with specific behavioral characteristics, psychological characteristics (“happy”), and so forth.

The profiles may be utilized to determine whether click or impression fraud occurs in advertising according to exemplary embodiments. For example, behavioral “fingerprints” can be captured in the profiles that make each user more unique and complex with each new interaction with websites or other content. Accordingly, the profiles of the various users may be continuously updated, making users highly targeted prospects. Further, a uniqueness of the behavioral experiences of users can be tracked. Thus, commercial entities 506, such as advertisers, can choose to only bid for users that the advertisers know are unique and not fraudulently generated. Advertisers can also measure the probability of a user being uniquely valid according to many behavioral dimensions and online behavioral history in order to ensure that the user being targeted for promotion is a unique user. In some embodiments, advertisers can specify the minimum number of behavioral interactions associated with users before a particular user is considered a target profile to which the advertiser wants to promote or sell. The server logic 510, or any other component, can check an identity of the users to determine areas of overlapping behavioral “fingerprints”, as discussed herein. Accordingly, the same user will not click on an advertisement twice, for example.

The profiles may be displayed to commercial entities 506 using graphics, charts, maps, and so forth. For example, a pie chart or line graph may indicate the demographic of users, according to their profiles, visiting a particular website of a commercial entity 506. Any type of presentation of the profiles is within the scope of various embodiments.

In some embodiments, interactive advertising and user requested content may be generated utilizing the user 202 information. For example, based on contextual, psycho-linguistic, psycho-demographic, and/or profile indexing, online and interactive advertising, advertorials, statistical, citationals, summaries, contactorials, productorials, briefings, collections, definitions, reader requests, and/or information surveys may be created. The advertising may then be displayed and distributed to other websites, syndicated locations, and so on.

Various manners of selling, or otherwise providing, the information, such as the profiles of the users 202 may be provided, according to some embodiments. For example, when a banner, text advertisement, online referral device or service, and so on is viewed by a visitor (i.e., the user 202) having certain psycho-linguistic characteristics or having a certain psycho-demographic profile or any other profile, an “impression” occurs. The “impression” may be considered a valid hit for purposes of collecting monies.

In some embodiments, clicks from users 202 having certain profiles may be measured from the tracking server 412 and/or the monitor 206. In another embodiment, an advertiser can buy an advertisement at the top of a webpage for a month. A duration placement occurs, for example, for a fixed time interval targeted at a certain psycho-linguistic dimension or psycho-demographic profile that visits across a network of web pages and web locations.

Any type of model for selling the various profiles of the users 202 may be employed according to various embodiments. For example, cost per thousand, cost per click, click-through rate, and/or conversion rate may be employed. For instance, the profiles allow a buyer, such as the commercial entities 506, to limit click-through impressions, or similar purchase methods, in favor of purchasing fewer, but more targeted advertisements, marketing materials, and so forth.

As discussed herein, various psychological parameters may be utilized by the psychological analysis engine 208 or any other component or program. For example, attitude dimensions can measure users' 202 points of view of the world and other people, events and concepts. Some of these parameters involve, but are not limited to, identifying common sense, personal sense, personal outlook, mannerisms, opinions, future concerns, inspiration, motivation, insight, beliefs, values, faith, reactions to actions, cultural surroundings, combativeness, litigiousness, personal preferences, social preferences, feelings of competence and sophistication. In one embodiment, profiles may be assigned weights and adjusted according to the websites visited by the users.

Behavioral dimensions may also comprise a psychological parameters. Behavioral dimensions may include measures of how users 202 behave and react to their situations, events, and other personal and worldly matters. Some of these dimensions involve, but are not limited to, identifying personal temperament, personality, disposition, character, emotional feelings, metaphysical beliefs, psychological state, criminality, need states, physical states, and processes of decision making.

Business dimensions are another example of psychological parameters. Business dimensions can measure users' 202 points of view of business matters. Some of these dimensions involve, but are not limited to, identifying economic factors, monetary factors, financial factors, risks, jobs/careers, work related tasks, talents, innovations, and skills.

Cognitive dimensions, for example, can measure how users 202 think. Some of these dimensions involve, but are not limited to, identifying ways of thinking, reasoning, intellectual quotient, memory, and self-concept. As another example, communications dimensions can measure how users 202 express and convey ideas, concepts, understandings, and thoughts. Some of these dimensions involve, but are not limited to, identifying verbalization, narration, acts of sharing, acts of statement, acts of publicizing, listening, gossiping, chatting, negotiation, musical expression, profanity, slang, euphemism, propaganda, media sources, readability, comprehension, speaking style, and writing style.

Other examples of psychological parameters include: consumer dimensions that measure users' 202 points of view regarding purchasing decisions, such as identifying brand sensitivity, lifestyle, leisure tendency, localized knowledge, and life cycles changes; demographic dimensions that measure users' 202 relationships in segments of the human population, such as, identifying age, audience appropriateness, gender, geographies, socioeconomic trends, income, ethnic and racial preference, nationality, product and service usage, spending and purchasing; social dimensions that can measures users' 202 social relationships to other people, organizations and ideals, such as group dynamics, individuality, team, family, friends, influences, leadership, credibility, membership, professionalism, politics, societal roles, and truthfulness; sensory and perceptual dimensions that can measure users' 202 understandings of the physical world around them through their senses, such as identifying visualizations, sound, tactility, time, spatiality, and relative place; and subject and special interest dimensions that can measure users' 202 interest in subjects and topics of knowledge and representation, such as subjects about general life and events, arts, humanities, business, trade, computers, technology, health, medicine, products, services, technical sciences, and social sciences. As discussed herein, any type of psychological parameters (e.g., psycho-analytic criteria) is within the scope of various embodiments.

While various embodiments have been described above, it should be understood that they have been presented by way of example only, and not limitation. For example, any of the elements associated with the user interaction based profiles may employ any of the desired functionality set forth hereinabove. Thus, the breadth and scope of a preferred embodiment should not be limited by any of the above-described exemplary embodiments.

What is claimed is:

1. A method for providing user interaction based profiles comprising:
monitoring one or more activities of a user associated with a network;
analyzing the one or more activities utilizing psychological parameters; and
generating a profile of the user based upon the analysis.

2. The method recited in claim 1, wherein the one or more activities comprise search requests.

3. The method recited in claim 1, wherein the one or more activities comprise user interaction with information obtained via the network.

4. The method recited in claim 1, further comprising providing the profile to a commercial entity.

5. The method recited in claim 4, further comprising allowing the commercial entity to utilize the profile to customize content.

6. The method recited in claim 1, further comprising assigning a category to the user according to the profile.

7. The method recited in claim 6, further comprising matching the category assigned to the user with a target audience associated with a commercial entity.

8. The method recited in claim 1, further comprising grouping the user with other users according to the profile.

9. The method recited in claim 8, further comprising accepting bids for the grouping of the users.

10. The method recited in claim 1, further comprising updating the profile based on continued monitoring of the one or more activities associated with the user.

11. The method recited in claim 1, further comprising providing tracking cookies on a computing device associated with the user.

12. The method recited in claim 11, further comprising matching the tracking cookies with advertising targets in order to provide customized advertisements.

13. A system for providing user interaction based profiles comprising:
a tracking server configured to monitor one or more activities of a user associated with a network; and
a psychological analysis engine configured to analyze the one or more activities utilizing psychological parameters and to generate a profile of the user based upon the analysis.

14. The system recited in claim 13, wherein the one or more activities comprise search requests.

15. The system recited in claim 13, wherein the one or more activities comprise user interaction with information obtained via the network.

16. The system recited in claim 13, wherein the tracking server is further configured to include user tracking cookies on a client associated with the user in order to monitor the one or more activities.

17. The system recited in claim 16, further comprising an advertising server configured to match the tracking cookies with advertising targets.

18. The system recited in claim 13, wherein the tracking server is further configured to update the profile based on continued monitoring of the one or more activities associated with the user.

19. A computer program embodied on a computer readable medium having instructions for providing user interaction based profiles comprising:
monitoring one or more activities of a user associated with a network;
analyzing the one or more activities utilizing psychological parameters; and
generating a profile of the user based upon the analysis.

20. The computer program recited in claim 19, wherein the one or more activities comprise search requests.

21. The computer program recited in claim 19, wherein the one or more activities comprise user interaction with information obtained via the network.

22. The computer program recited in claim 19, further comprising providing the profile to a commercial entity.

23. The computer program recited in claim 22, further comprising allowing the commercial entity to utilize the profile to customize content.

24. The computer program recited in claim 19, further comprising assigning a category to the user according to the profile.

25. The computer program recited in claim 24, further comprising matching the category assigned to the user with a target audience associated with a commercial entity.

26. The computer program recited in claim 19, further comprising grouping the user with other users according to the profile.

27. The computer program recited in claim 26, further comprising accepting bids for the grouping of the users.

28. The computer program recited in claim 19, further comprising updating the profile based on continued monitoring of the one or more activities associated with the user.

29. The computer program recited in claim 19, further comprising providing tracking cookies on a computing device associated with the user.

30. The computer program recited in claim 19, further comprising matching the tracking cookies with advertising targets in order to provide customized advertisements.
